(19) United States
(12) Patent Application Publication
(10) Pub. No.: US 2016/0144672 A1
(43) Pub. Date: May 26, 2016

(54) AIR COMPRESSOR ABLE TO INFLATE AND REPAIR TIRE

(71) Applicant: Min-Hsieng Wang, Taipei (TW)

(72) Inventor: Min-Hsieng Wang, Taipei (TW)

(21) Appl. No.: 14/791,234

(22) Filed: Jul. 2, 2015

(30) Foreign Application Priority Data
Nov. 20, 2014 (TW) 103220570

(51) Int. Cl. B60C 23/00; B29C 73/02; F04B 35/04

(52) U.S. Cl. CPC B60C 23/001; F04B 35/04; B29C 73/02

(57) ABSTRACT

An air compressor includes a housing having a front cap provided with a switch therein and a rear cap able to store a cigarette lighter, a cigarette lighter's cable and an air tube therein, an inflator having a pressure gauge, a pressure release button and a vent joint, a connecting unit having a cylinder insertion connected to the vent joint of the inflator, a connector insertion and an unfastening button, a changeover valve having a connector inserted into the connector insertion of the connecting unit and a changeover button and a tire repair solution can connected with the changeover valve. In order to make a changeover between air inflation and tire repair solution, it can be simply done by swiveling the changeover button.

### BACKGROUND OF THE INVENTION

1. Fields of the invention

The present invention relates to an air compressor, and more particularly, to an air compressor able to inflate and repair tire so as to be easily carried and used friendly.

2. Descriptions of Related Art

Car industrial are getting competitive by time because the technology is being developed promptly, so, the car accessories are also being innovated. An air compressor would be first option in case of tire inflation, however, the most of products for tire inflation are able to supply either compressed air or tire repair solution into tires which means the two features can't be integrated in an air compressor. Although there are some products able to integrate air compressor and tire repair solution supply in a device, it still requests a mechanical connection while operating and the operating steps are complex which means the products seems having duo features but actually it doesn't.

### SUMMARY OF THE INVENTION

The present invention intends to provide a portable air compressor able to inflate and repair tire that effectively improves the shortcomings mentioned above.

The air compressor in the present invention is consisted of a housing, an inflator, a connecting unit, a changeover valve and a tire repair solution can. The housing has a front cap and a rear cap. At the corner of the front cap and the rear cap is respectively defined an opening able to correspond to each other. The front cap has a switch hole able to be inserted a switch therein, a first hole, a second hole and a third hole. The rear cap has a recess able to store a cigarette lighter therein, a cable reception able to store the cigarette lighter's cable therein and a tube reception. The inflator defined inside of the housing has a pressure gauge placed in the first hole of the front cap, a pressure release button placed in the second hole of the front cap and a vent joint. The connecting unit defined inside of the housing has a connector insertion, a cylinder insertion able to be inserted by the vent joint of the inflator and an unfastening button placed on literal side of the housing. The changeover valve defined inside of the housing has a connector able to be inserted into the connector insertion of the connecting unit, an air tube able to be stored in the tube reception of the rear cap therein, and a changeover button placed in the third hole of the front cap therein. The tire repair solution can placed inside of the housing is connected to the changeover valve.

The advantage in the present invention is that it can integrate air inflation and tire repair solution supply in an air compressor and a changeover between air inflation and tire repair solution could be simply done by swiveling a changeover button. Furthermore, the tire repair solution can is easily replaced in case of running out of the solution. Besides, although the tire repair solution can is merged into the air compressor, the volume of the air compressor isn't enlarged so as to the air compressor could be carried.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of an air compressor in the present invention;

FIG. 2 is an exploded perspective view of a connecting unit of the air compressor in the present invention;

FIG. 3 is a schematic view showing a cigarette lighter and an air tube stored on the rear cap of the air compressor in the present invention;

FIG. 4 is a perspective view of the air compressor in the present invention;

FIG. 5 is a cross sectional view of the air compressor in the present invention;

FIG. 6 is a cross sectional view of a inflator of the air compressor in the present invention;

FIG. 7 is a cross sectional view of a tire repair solution can and a changeover valve of the air compressor in the present invention

FIG. 8 is a schematic view showing the air compressor in condition of air inflation in the present invention;

FIG. 9 is a schematic view showing the air compressor in condition of tire repair solution delivery in the present invention;

FIG. 10 is a schematic view showing a connecting unit of the air compressor in condition of unfastening in the present invention, and

FIG. 11 is a schematic view showing installation or replacement of a tire repair solution can of the air compressor in the present invention.

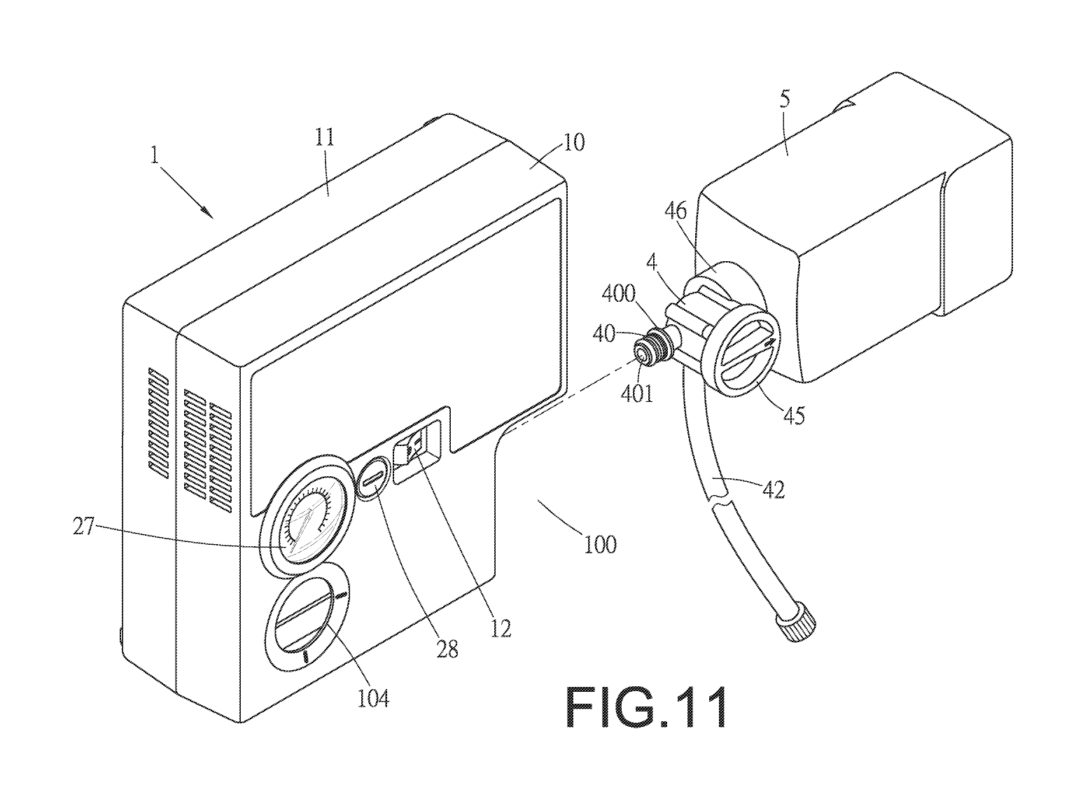

### DETAILED DESCRIPTION OF THE PREFERRED EMBODIMENT

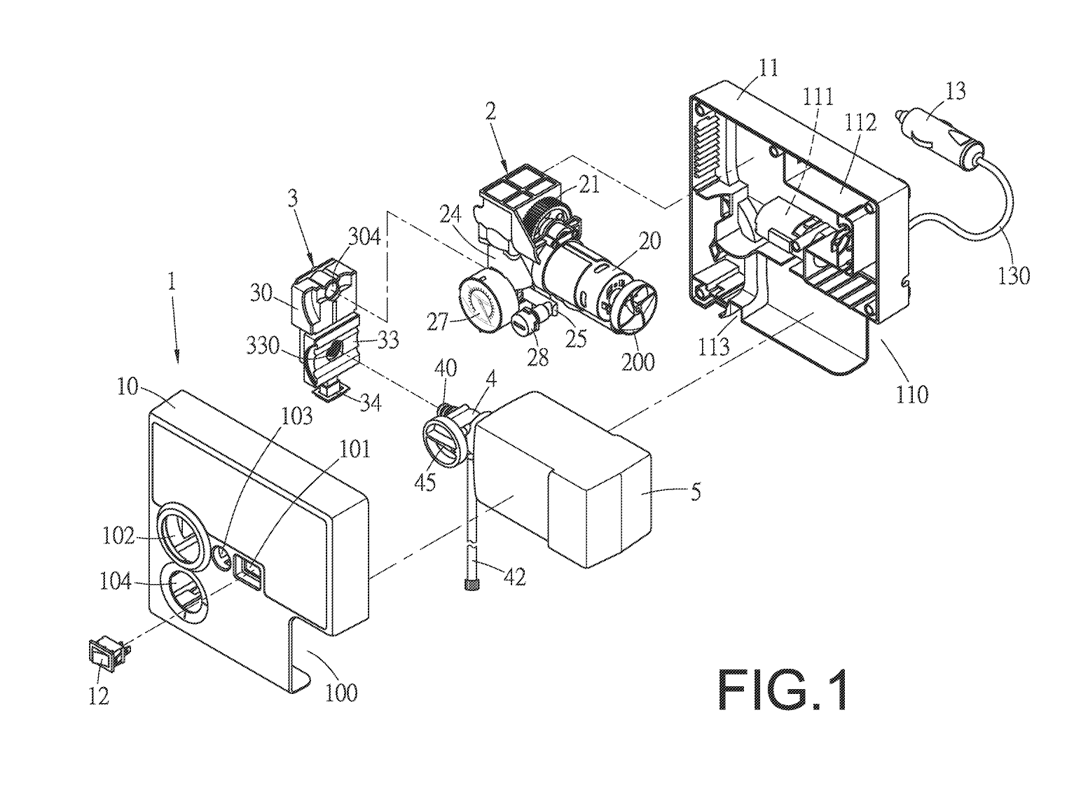

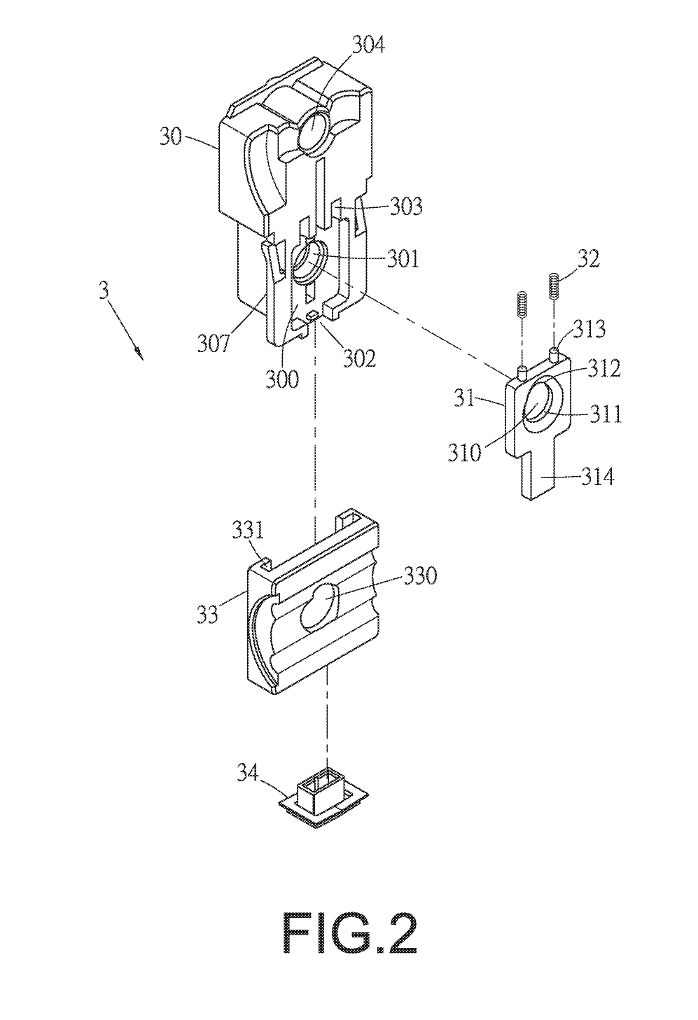

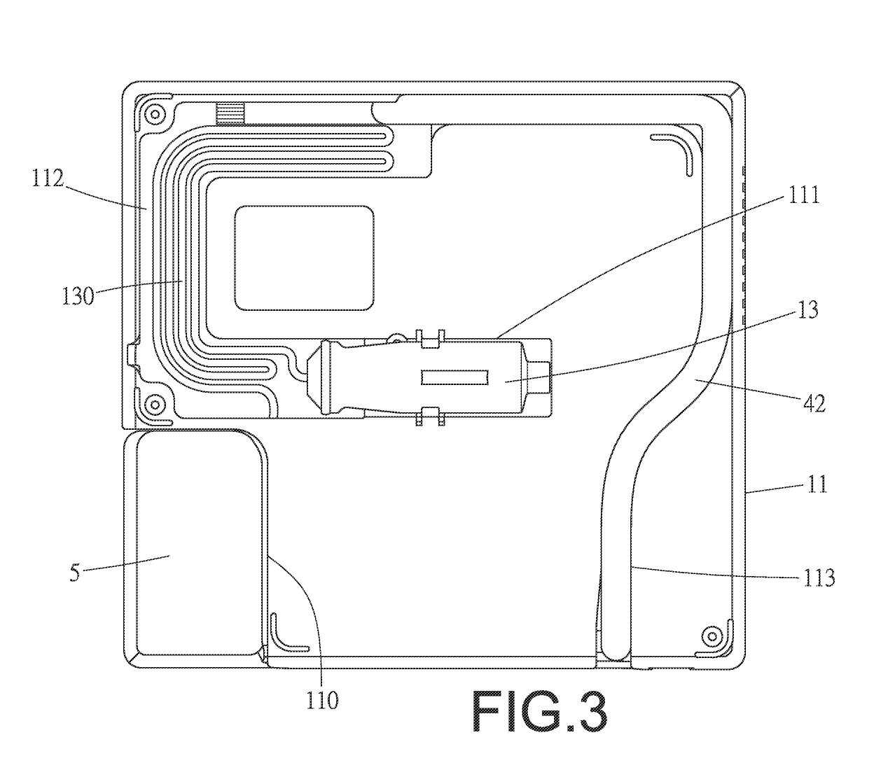

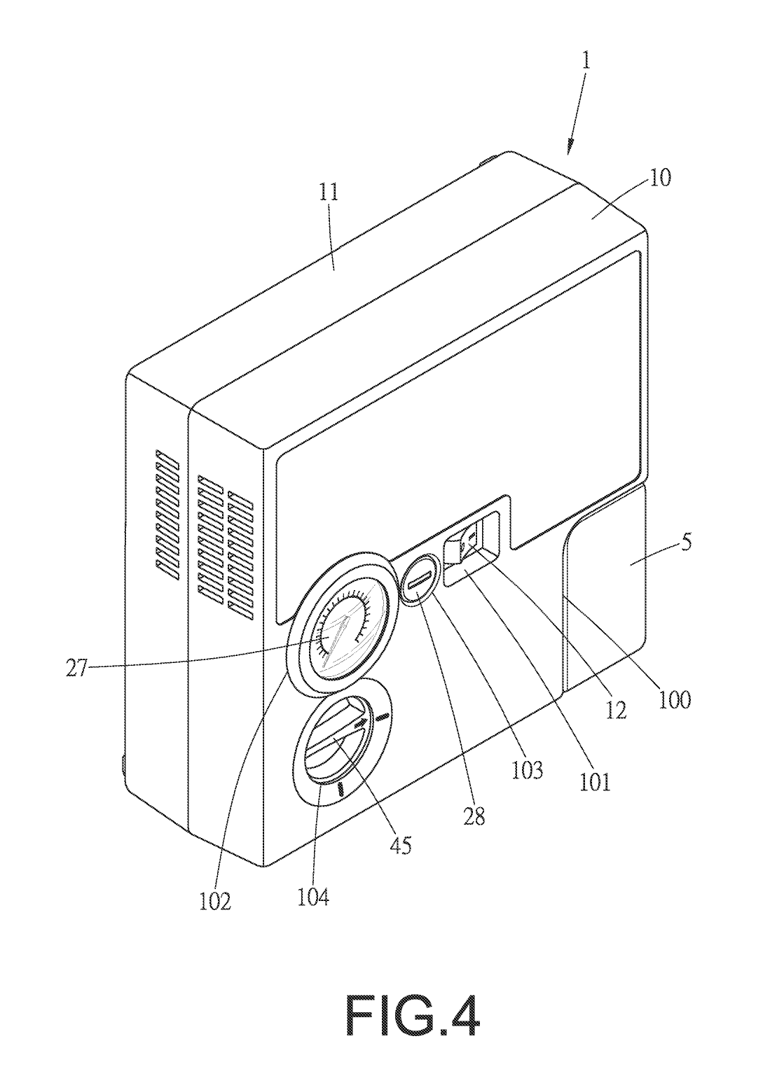

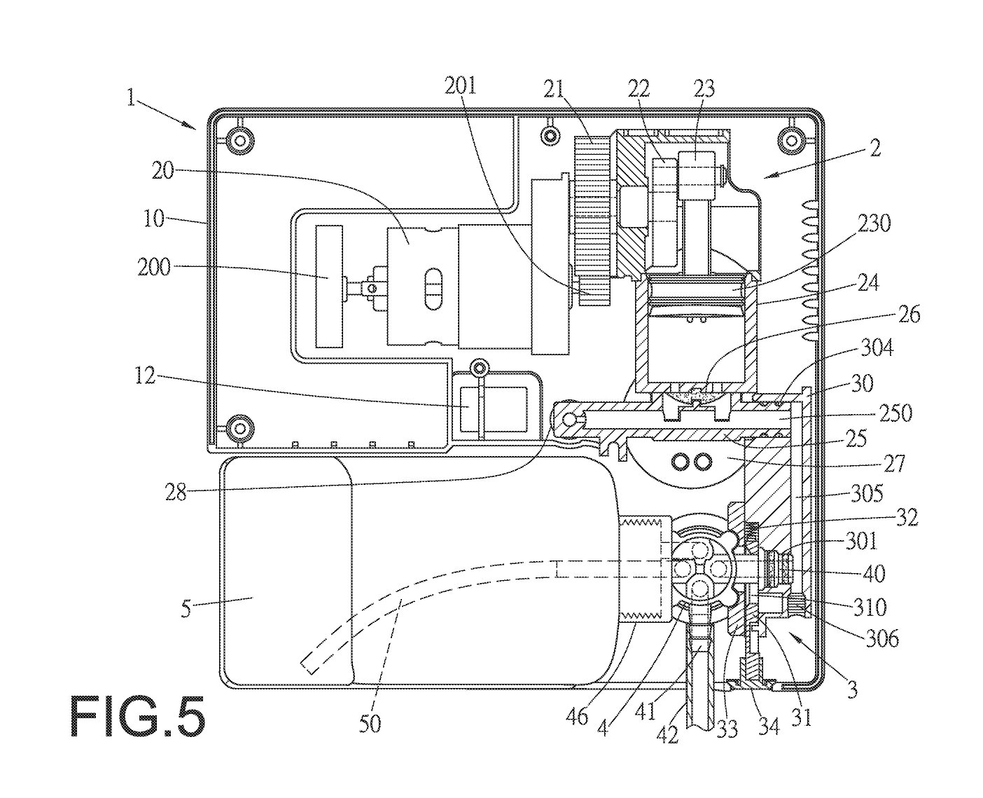

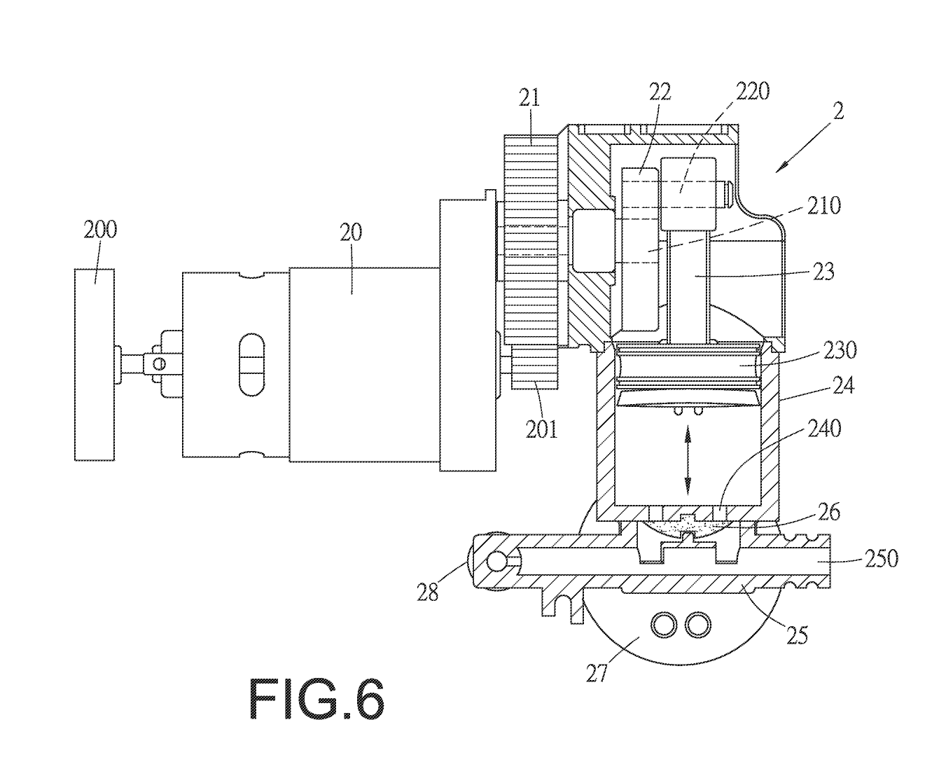

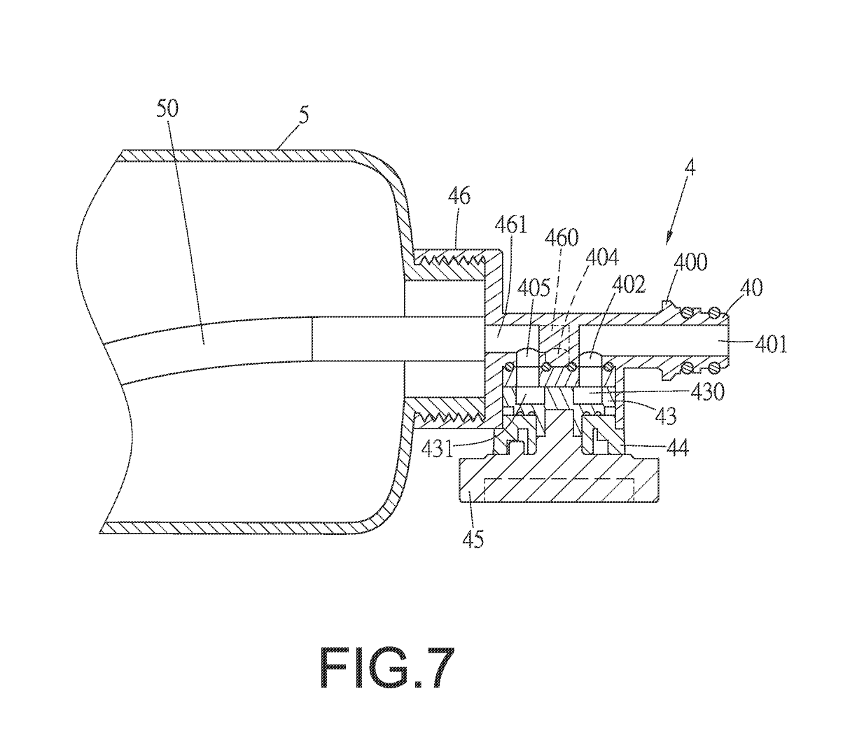

By referring to FIGS. 1 to 8, a preferable embodiment of an air compressor in this present invention is consisted of a housing 1, an inflator 2, a connecting unit 3, a changeover valve 4 and a tire repair solution can 5. The housing 1 has a front cap 10 and a rear cap 11. At the corner of the front cap 10 and the rear cap 11 is respectively defined an opening 100 and 110. The front cap 10 has a switch hole 101 able to be inserted a switch 12 therein, a first hole 102, a second hole 103 and a third hole 104. The rear cap 11 has a recess 111 able to store a cigarette lighter 13 therein, a cable reception 112 able to store a cable 130 of the cigarette lighter 13 therein and a tube reception 113 as shown on FIG. 3. As shown on FIGS. 5 and 6, the inflator 2 defined inside of the housing 1 is provided a motor 20 having plural fins 200 on a literal side and a subordinate gear 201 on the other literal side. A transmission gear 21 meshed with the subordinate gear 201 is provided a spindle 210 connected to a cam 22 eccentrically connected to a rotor 220 and a shaft 23. A piton 230 on topside of the shaft 23 is inserted into a cylinder 24 having plural air holes 240 and a vent joint 25. Inside of the vent joint 25 is provided a movable valve plate 26 used to seal the air holes 240 on the cylinder 24. The vent joint 25 is provided a vent 250 and connected to a pressure gauge 27 and a pressure release button 28. As shown on FIGS. 2, 5 and 8, the connecting unit 3 defined inside of housing 1 is composed of a holder 30, a board 31, two springs 32, a fixing base 33, and an unfastening button 34. The holder 30 is provided a concave 300 having a connector insertion 301. The concave 300 is provided an opening 302 outside and two recesses 303 inside. The holder 30 is also provided a cylinder insertion 304 which is communicated with the connector insertion 301 by a passage 305 which is provided a stopper 306 at outer end of the passage 305. At two opposite literal walls are respectively defined a guiding railway 307. On the board 31 is defined an engaging hole 310 composed of two round holes with two different diameters so as to form an inserting portion 311 and an engaging portion 312. One end of the two springs 32 are separately inserted into two projectors 313 on end of the board 31 and the other end of the two springs 32 are separately inserted into the two recesses 303 inside of the holder 30 so that the board 31 is able to be elastically abutted outward. The other end of the board 31 is provided a connecting member 314 able to be inserted through the opening 302 of the holder 30. The fixing base 33 inserted into the holder 30 is provided a round hole 330 corresponding to the connector insertion 301 and two guiding grooves 331 defined respectively on two literal sides of the fixing base 33 able to be inserted by the guiding railways 307 on the holder 30. The fixing base 33 is able to restrict the board 31 inside of the concave 300 of the holder 30. The unfastening button 34 connected by the connecting member 314 of the board 31 is placed at bottom (or literal) side of the housing 1. The changeover valve 4 placed inside of the housing 1 has a connector 40 able to be inserted into the connector insertion 301 of the connecting unit 3. The connector 40 is disposed a flange 400 being engaged with the engaging portion 312 of the board 31 of the connecting unit 3 in order to be positioned. The connector 40 is provided an air intake passage 401 therein. Inside of the changeover valve 4 is disposed an air intake hole 402, a tire connecting hole 403, an air outlet hole 404 and a solution hole 405. The air intake hole 402 is communicated to the air intake passage 401. The changeover valve 4 is provided a joint 41 therein. Inside of the joint 41 is disposed a connecting passage communicated with the tire connecting hole 403. The joint 41 is connected to an air tube 42 which is able to be stored in the tube reception 113 outside of the rear cap 11 (as shown on FIG. 3). Inside of the changeover valve 4 is provided a movable ceramic plate 43 consisted of first passing groove 430 and second passing groove 431 (as shown on FIG. 7) and provided a fixing member 44 thereon. A changeover button 45 disposed on the fixing member 44 is inserted through the fixing member 44 and connected with the movable ceramic plate 43. On a literal side of the changeover valve 4 is provided a swivel joint 46 connected to the tire repair solution can 5. On the swivel joint 46 is provided an air outlet passage 460 communicated with the air outlet hole 404 and a solution passage 461 communicated with the solution hole 405. Inside of the tire repair solution can 5 is provided a solution tube 50 connected to the solution passage 461 of the swivel joint 46. Here is the construction of the air compressor able to inflate and repair tire in the present invention.

As shown on FIGS. 1˜5 in assembling, first of all, the vent 250 of the vent joint 25 of the inflator 2 is inserted into the cylinder insertion 304 of the connecting unit 3 and the connector 40 of the changeover valve 4 is inserted into the connector insertion 301 of the connecting unit 3 which means the connector 40 would push the board 31 inwardly so that the inserting portion 311 of the engaging hole 310 of the board 31 could be corresponded to the connector 40 of the changeover valve 40 in order to push the connector 40 being inserted into the inserting portion 311 of the engaging hole 310 of the board 31. The board 31 would be pushed outwardly by elasticity recovery of the spring 32 and then the connector 40 of the changeover valve 4 is able to be inserted into the engaging portion 312 of the engaging hole 310 of the board 31 so that the flange 400 of the connector 40 is abutted on a literal side of the board 31 in order to fix the changeover valve 4 in the connecting unit 3. Afterward, the tire repair solution can 5 is connected to the swivel joint 46 of the changeover valve 4. The inflator 2, the connecting unit 3, the changeover valve 4 and the tire repair solution can 5 would be installed inside of the rear cap 11 of the housing 1 and then the front cap 10 is used to seal the rear cap 11. The part of the tire repair solution can 5 would be placed between the opening 100 of the front cap 10 and the opening 110 of the rear cap 11. The pressure gauge 27 of the inflator 2 would be placed in the first hole 102 of the front cap 10, the pressure release button 28 of the inflator 2 would be placed in the second hole 103 of the front cap 10 and the changeover button 45 of the changeover button 4 would be placed in the third hole 104 of the front cap 10. This is the assembly of the air compressor able to inflate and repair tire in the present invention.

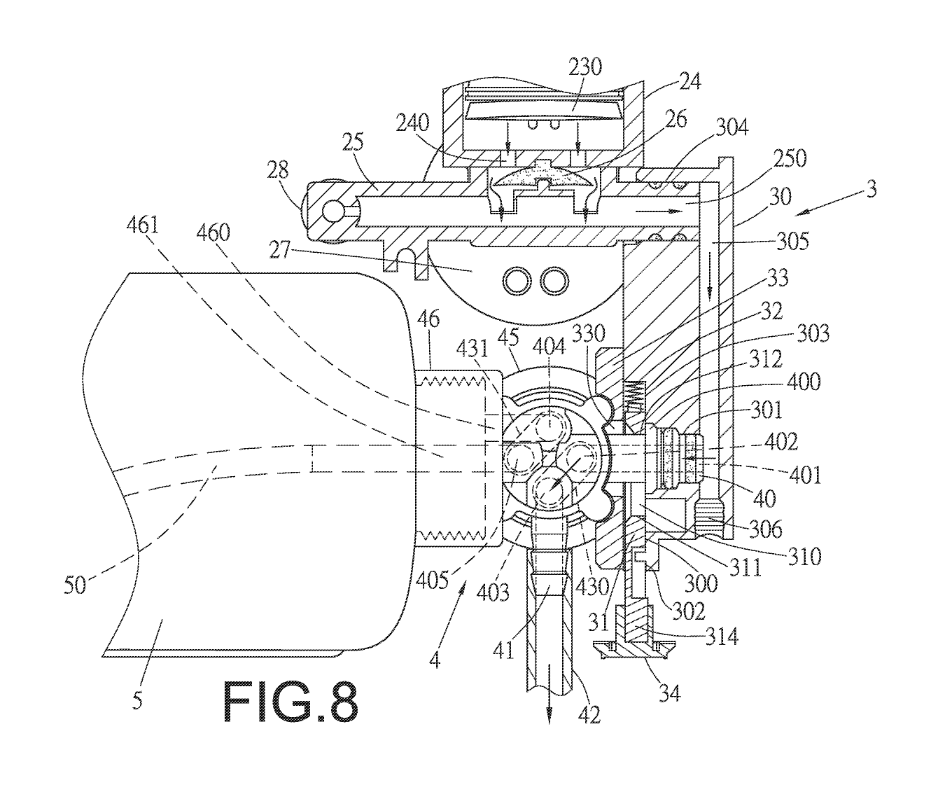

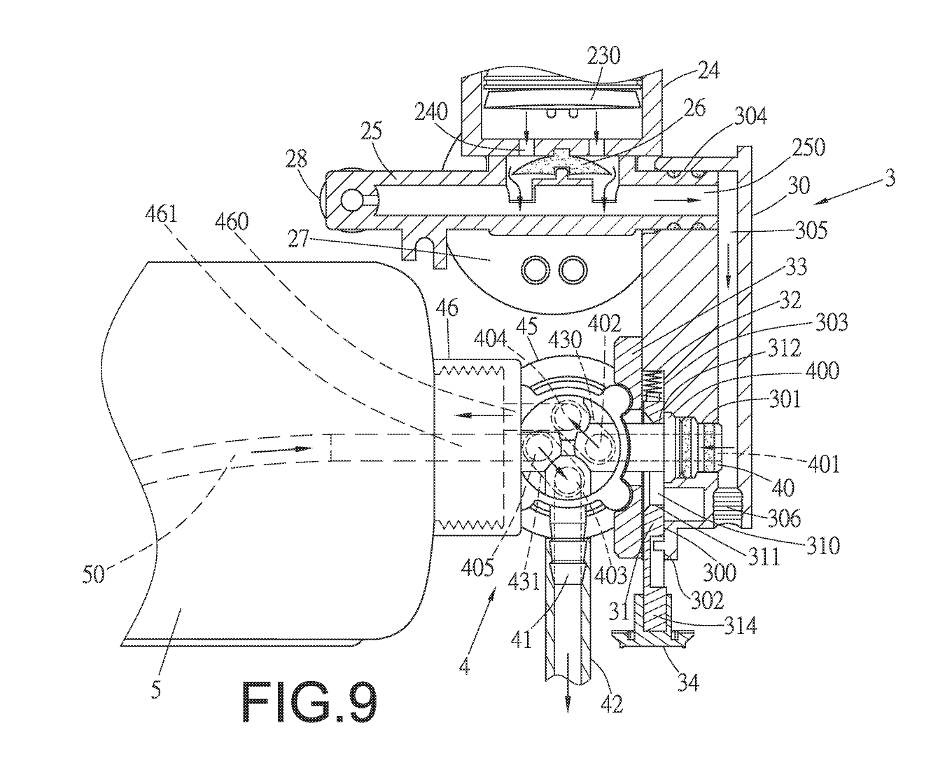

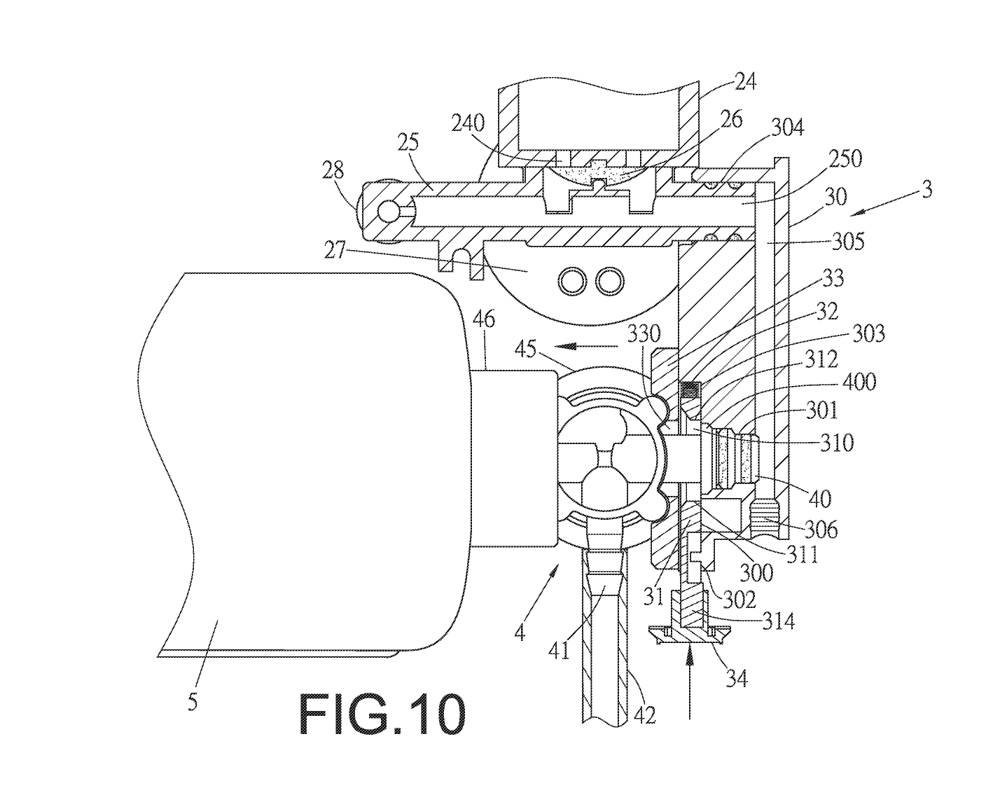

As shown on FIGS. 8˜11 in using, in case of realizing air leakage from a tire, the cigarette lighter 13 is plugged into the cigarette lighter socket of a vehicle firstly and then the changeover button 45 is swiveled to air inflation position as shown on FIG. 8 so that the first passing groove 430 of the movable ceramic plate 43 inside of the changeover valve 4 is able to correspond to the air intake hole 402 and the tire connecting hole 403. Then, the motor 20 of the inflator 2 would be operated by pushing the switch 12 on the front cap 10 in order to compress air. The compressed air would be delivered out through the vent 250 of the vent joint 25 and passed through the air intake passage 401 of the changeover valve 4 via the passage 305 of the connecting unit 3. The compressed air would be guided into the tire connecting hole 403 by the air intake hole 402 and the first guiding groove 430 of the movable ceramic plate 43 so that the compressed air is exhausted from the air tube 42 of the joint 41 in condition of tire inflation. However, in case of realizing a hole on a tire and intending to repair, the changeover button 45 is swiveled to tire repair solution position as shown on FIG. 9 so that the first passing groove 430 of the movable ceramic plate 43 inside of the changeover valve 4 is able to correspond to the air intake hole 402 and the air outlet hole 404 and the second passing groove 431 is able to correspond the tire connecting hoe 403 and the solution hole 405. Then, the motor 20 of the inflator 2 would be operated by pushing the switch 12 on the front cap 10 in order to compress air. The compressed air would be delivered out through the vent 250 of the vent joint 25 and passed through the air intake passage 401 of the changeover valve 4 via the passage 305 of the connecting unit 3. The compressed air would be guided into the air outlet hole 404 by the air intake hole 402 and the first guiding groove 430 of the movable ceramic plate 43 so that the compressed air would be delivered inside of the tire repair solution 5 through the air outlet passage 460 of the swivel joint 46 in order to be compressed. The solution inside of the tire repair solution can 5 would be squeezed into the solution hole 405 through solution passage 461 via the solution tune 50 by the compressed air. The solution would be guided into the tire connecting hole 403 by the second guiding groove 431 of the movable ceramic plate 43 so that the solution is exhausted from the air tube 42 of the joint 41 in condition of the tire repair solution delivery. After delivering the solution into the tire, the changeover button 45 would be swiveled back to the air inflation position so as to inflate the tire by following the above mentioned steps. Further, in case of solution refiling or replacement of the tire repair solution can 5 because of running out of the solution, the unfastening button 34 underneath of the housing 1 would be pushed (as shown on FIG. 10) so that the unfastening button 34 would drive the board 31 moving inwardly in order to compress the spring 42 being in condition of elasticity compression. The engaging portion 312 of the engaging hole 310 of the board 31 would be disengaged from the connector 40 of the changeover valve 4 which means the inserting portion 311 would correspond to the connector 40 and the flange 400 isn't longer being abutted by the inserting portion 312 so as to be unfastened. The connector 40 being free from the engaging hole 310 of the board 31 is removed from the connector insertion 301 of the holder 30, hence, the tire repair solution can 5 connected with the changeover valve 4 could be removed from the housing 1 and then the tire repair solution can 5 could be swiveled in order to be released from the changeover valve 4. The tire repair solution can 5 can be refilled with new solution or be replaced by a new can. The present invention is described that it can integrate air inflation and tire repair solution supply in an air compressor and a changeover between air inflation and tire repair solution could be simply done by swiveling a changeover button 45. Furthermore, the tire repair solution 5 can is easily replaced if it was ran out of the solution. Besides, even though the tire repair solution can 5 is merged into the air compressor, the volume of the air compressor isn't enlarged so as to the air compressor could be carried.

While we have shown and described the embodiment in accordance with the present invention, it should be clear to those skilled in the art that further embodiments may be made without departing from the scope of the present invention.

What is claimed is:

1. An air compressor is consisted of:
a housing having a front cap and a rear cap wherein at the corner of the front cap and the rear cap respectively defined an opening able to correspond to each other, the front cap provided a switch hole able to be inserted a switch therein, a first hole, a second hole and a third hole, and the rear cap provided a recess able to store a cigarette lighter therein, a cable reception able to store the cigarette lighter's cable therein and a tube reception,
an inflator inside of the housing having a pressure gauge placed in the first hole of the front cap, a pressure release button placed in the second hole of the front cap and a vent joint,
a connecting unit defined inside of the housing having a connector insertion, a cylinder insertion able to be inserted by the vent joint of the inflator and an unfastening button placed on literal side of the housing, a changeover valve defined inside of the housing has a connector able to be inserted into the connector insertion of the connecting unit, an air tube able to be stored in the tube reception of the rear cap therein, and a changeover button placed in the third hole of the front cap therein, and
a tire repair solution can connected to the changeover valve inside of the housing.
